(19) United States
(12) Patent Application Publication
(10) Pub. No.: US 2012/0280797 A1
(43) Pub. Date: Nov. 8, 2012

(54) System And Apparatus For Item Level Inventory Management Within A Virtual Warehouse Established For Short-Term And Long-Term Disaster Relief Operations

(75) Inventor: Richard C. Meyers, Longboat Key, FL (US)

(73) Assignee: System Planning Corporation, Arlington, VA (US)

(21) Appl. No.: 13/288,824

(22) Filed: Nov. 3, 2011

Related U.S. Application Data
(60) Provisional application No. 61/411,282, filed on Nov. 8, 2010.

(51) Int. Cl. G06Q 30/00; G06K 7/01

(52) U.S. Cl. 340/10.5; 235/385

(57) ABSTRACT

This invention describes a system and method for managing a supply chain. In particular, the present invention relates to a virtual warehouse system for providing item level inventory management and an apparatus for automatic data capture within a disaster relief operational setting.

### PRIORITY CLAIM

The present invention claims priority to U.S. Provisional Patent Application No. 61/411,282, filed Nov. 8, 2010. No new matter has been added.

### BACKGROUND OF THE PRESENT INVENTION

1. Field of the Present invention

The present invention relates to a system and apparatus for managing a supply chain. More particularly, the present invention relates to a virtual warehouse system for providing item level inventory management and an apparatus for automatic data capture within a disaster relief operational setting.

2. Description of Related Art

Warehouse management deals with receipt, storage and movement of goods, normally finished goods, to intermediate storage locations or to a customer. In the multi-echelon model for distribution, there are generally three levels of warehouses including central warehouse(s), regional warehouses and retail warehouses. The objective of the warehouse management system is to optimize shipping costs and timely order fulfillment. However, the commercial warehouse system remains a traditional model requiring that a company or consumer place an order, which is received and fulfilled in the order in which received.

Today, some advanced commercial warehouse management systems may utilize Auto ED Data Capture (AIDC) technology to a limited extent utilizing barcode scanners, mobile computers, and wireless LANs. The potential for using radio-frequency identification (RFID) technology to monitor the flow of products is immature.

The large-scale regional disaster caused by Hurricane Katrina in 2004 tested the capabilities of the Federal Emergency Management System (FEMA); the flooding in New

Orleans which had affected such a large densely populated area so quickly, revealed shortcomings in the FEMA management systems. FEMA officials publicly admit that supply chain management for disaster relief remains is an area in which FEMA needs to be improved.

### SUMMARY OF THE PRESENT INVENTION

According to one aspect of the present invention, a virtual warehouse system is provided which may be configured based on geography, supply levels and the needs of the customer or end-user. In a preferred implementation of the present invention, each product in the virtual warehouse system will be identified by an item number, location number identifier, and operational code which may he stored on an RFID tag preferably as small as 0.3 mm/chip. The identifying data and location of each item may be transmitted to a central database accessible to supply chain managers who may access and analyze data to adjust supply levels and maintain adequate stock within the virtual warehouse. Preferably, the information stored on an RFID tag may be updated and/or modified as needed based on changes in the boundary of the virtual warehouse. The real-time data capture capability within the virtual warehouse model allows for more efficient placement of disaster relief assets such as drop points, exchange points and points of distribution. In addition, the design of the virtual warehouse may be rearranged quickly to meet new demands and needs.

Further embodiments of the present invention are presented below in order to overcome the shortcomings disclosed in the prior art. The accompanying drawings, which are incorporated in and constitute part of the specification, illustrate various embodiments of the present invention and together with the description, serve to explain the principles of the present invention.

### BRIEF DESCRIPTION OF THE DRAWINGS

FIG. 1 is a schematic diagram illustrating a supply chain moving commodities as shown in the prior art.

FIG. 2 is a schematic diagram illustrating a virtual warehouse according to an embodiment of the present invention.

FIG. 3 is a block diagram of a reading device according to an embodiment of the present invention.

FIG. 4 is a flowchart illustrating the pre-disaster steps to building a virtual warehouse according to an embodiment of the present invention.

FIG. 5 shows a flowchart illustrating a method for conducting post-disaster operations according to an embodiment of the present invention.

FIG. 6 is a functional configuration of a microcontroller unit according to an embodiment of the present invention.

FIG. 7 is a functional configuration of a sensing control element according to an embodiment of the present invention.

### DESCRIPTION OF THE PREFERRED EMBODIMENTS

For the purposes of promoting an understanding of the principles of the present invention, reference will now be made to the embodiments illustrated in the drawings and specific language will be used to describe the same. It will nevertheless be understood that no limitation of the scope of the present invention is hereby intended and such alterations and further modifications in the illustrated devices are contemplated as would normally occur to one skilled in the art.

The purpose of the present invention is to equip a logistics management directorate with the technological means to manage a virtual supply chain within a strategic alliance of regional offices to efficiently distribute supplies, equipment and services to support emergency and disaster relief operations.

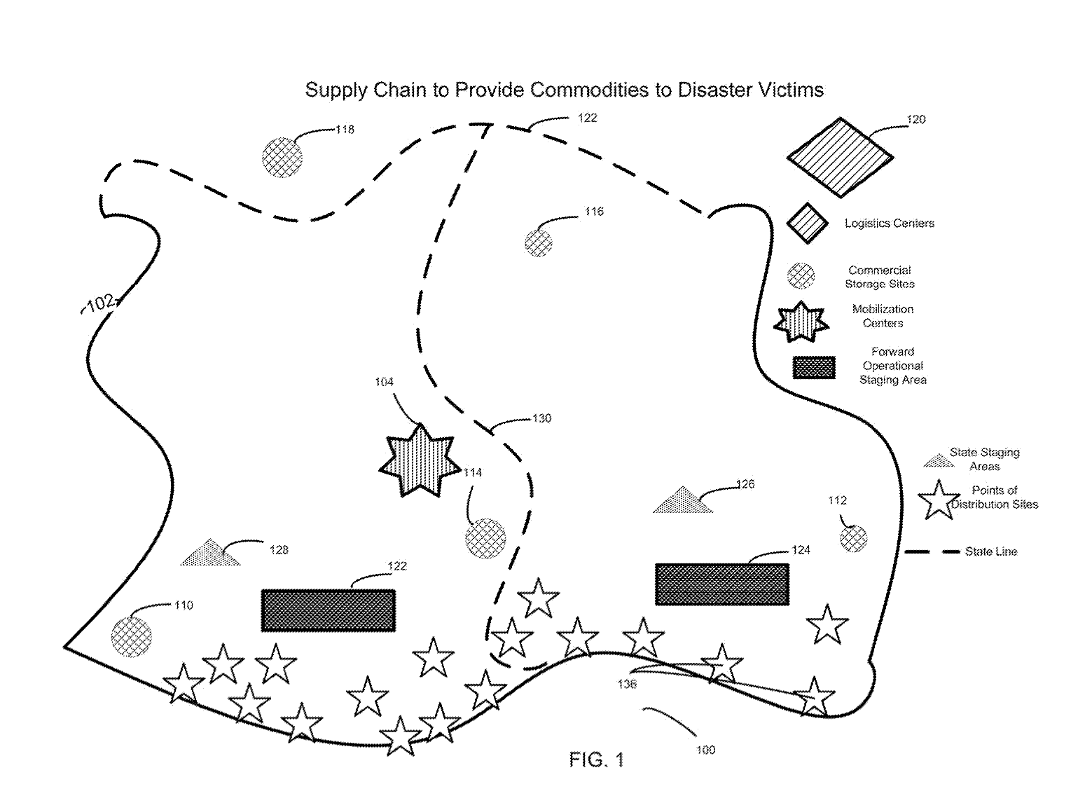

With reference now to FIG. 1, the details of a schematic illustration of a supply chain management system to provide commodities to disaster victims as shown in the prior art 100 will now be discussed. As shown in FIG. 1, a disaster area 102 encompassing an area spanning two states and across a state line 108. A logistics center 120, a permanent facility that receives, stores, ships and recovers disaster commodities and equipment, serves as headquarters. Commodities purchased from vendors are housed and managed at the logistics center 120.

Command and control personnel operating from the logistics center 120 communicate and coordinate operations with the following temporarily established operation centers and warehousing facilities as shown: a mobilization center 104, staging areas 128/126, and commercial storage sites 110, 112, 114, 116, 118. The commercial storage facilities 110 and 114 are freezer storage units in this scenario. Commercial storage units 114 and 116 are storing finished product and commercial storage unit 118 in this scenario is across the northern border of the state line 122.

As further shown in FIG. 1, a mobilization center (MOB) 104 which serves as temporary facilities in a theater at which commodities, equipment, and personnel can be received and pre-positioned for deployment as required. These commodities remain under the control of HQ logistics and may be deployed to multiple states; mobilization centers 104 are generally projected to hold three days of commodities. The MOB 104 supplies the Forward Operational Staging Areas (FOSA) 122/124 which can accommodate 1-2 days supplies and operate under the command and control of the MOB 104. The FOSA 122/124 transfers commodities to designated points of distribution (POD) 136 where commodities may be directly distributed to disaster victims.

Under the prior art supply chain management system 100 as shown in FIG. 1, many serious disadvantages are encountered which lead to inaccuracies and delays which may have a negative impact on disaster victims. As shown in FIG. 1, the supply chain management system 100 relies on levels above and below to update inventories and make requests for additional supplies. In situations where temporary facilities such as the MOB 104, FOSA 122/124, state staging areas 126/128, and POD 136 are rapidly deployed to respond to a situation, standard operating procedures may not be in place from site to site creating system wide delays in response time. Thus the communication systems of the supply chain management system 100 may experience breakdowns which will further delay commodity resupply. These communication delays may seriously hinder the command and control in the logistic center 120 and the MOB 104 from making timely decisions due to incomplete and untimely information.

The present invention will allow for a “customer driven” bottom up requirement process, in which orders may be entered at the supply point automatically and on a preprogrammed basis to request a pull of resources. Preferably, the order may be logged by the command center and sent to the supplier simultaneously, which may prepare orders for shipment directly to the distribution point from which initiated.

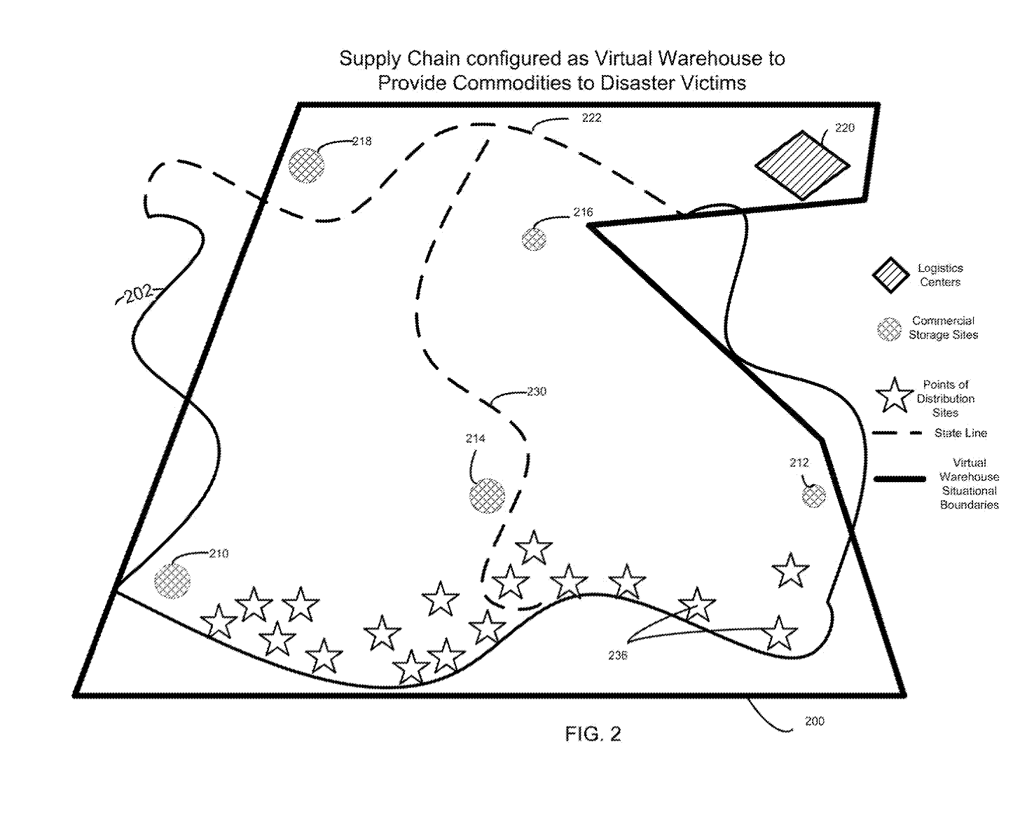

With reference now to FIG. 2, a schematic diagram illustrating an embodiment of a virtual warehouse according to an embodiment of the present invention will now be discussed. As shown in FIG. 2, the same disaster scenario as described in FIG. 1. a disaster area 202 encompassing two states and across a state line 208. As further shown in FIG. 2, the logistically defined boundary of the virtual warehouse 200 is specifically defined to the situational needs of the present disaster. in this process, the virtual warehouse 200 is determined and defined by the detected supply components. Within the virtual warehouse 200, the command and control unit of the logistic center 220 will be able to view commodities in a real time tracking system at the item level. Updating the automatic capture of data can become routinely set so that data needed for decision-making processes is up-to-date and reliable.

Operating a supply chain within the virtual warehouse system 200 requires all supply items to have an RFID tag with an embedded identifier code with pertinent information (i.e. expiration dates, location identifier, supplier information, operation identifier, etc.) All sites, centers, and points of distribution may have at least one RFID Reader/GPS unit 300 to transmit information to the central databases and the logistics center 220. Preferably, the logistics center 220 can initiate an automatic date capture from any individual site on a regularly scheduled pre-programmable basis.

Preferably, real time inventory and location tracking can be occurring at any level down to the points of distribution 224 for the most accurate assessment of distribution effectiveness. Resupply can be shipped directly from midlevel facilities such as the commercial storage facilities of 218, 216, 214, 212, 210, to distribution points 224 while maintaining item level accountability. Furthermore, resupply from anywhere within the virtual warehouse may be expedited as future needs are anticipated based on present demand as supply chain flow is managed by the real time tracking system within the virtual warehouse.

In conducting a virtual warehouse, preferably operational components will not become entrenched, but instead remain flexible and agile to meet the demands of the dynamics of the operation. In the field of operation of the disaster area as described in FIG. 2, mid-level command and control entities such as the mobilization center, forward staging areas, and state staging areas are absent within the virtual warehouse. The boundaries of a virtual warehouse are defined by the positioning of the RFID Reader/GPS units and the needs of the operational conditions. The boundaries are fluid according to the flow of the situation. Ideally, disaster relief is administered until conditions can be normalized. In the present invention, therefore, the lines of relief operations may remain adaptable as the situation dictates.

Aspects of the traditional disaster relief supply chain such as the mobilization centers, state staging areas and forward operational staging areas may be significantly downsized or eliminated altogether thus simplifying the overall operational system and significantly reducing costs. Preferably, the benefits of automatic data capture from any point in the supply chain and the added capability of meeting the needs from the bottom up, may reduce the built-in redundancy of the larger more cumbersome disaster relief supply chain model. Streamlining the way resources are deployed, the present invention results in meeting the needs of a greater number of consumers in less time.

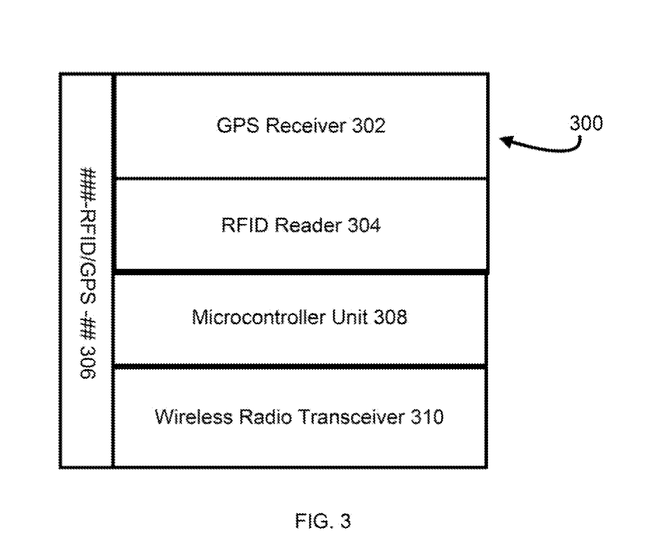

With reference now to FIG. 3, a block diagram illustrating an RFID reader/GPS unit 300, which hereafter will be referred to as “the reading device”, according to a preferred embodiment of the present invention will now be discussed. As shown, the reading device of the present invention includes an RFID reader 304, a GPS receiver 302, a Microcontroller Unit 308, and a wireless radio transceiver 310. Each reading device 300 has a unit specific identifier code 306. The reading device is capable of reporting its location, reading RFID tag information, processing and reporting the information stored on RFID tags, receiving messages and remote commands, and storing information. The present invention allows real time automatic data capture within a supply chain that simplifies the logistical operations within a disaster relief situation.

The RFID reader 304 in the reading device may be employed as a fixed RFID reader or a mobile RFID reader. Preferably, the RFID reader has a range that is programmable by setting the signal strength in the software in a range from between 10 Feet to 450 Feet (free air) depending upon the environmental conditions and the type of RFID tags used. In one aspect of a preferred embodiment of the present invention, the reading device may include an antenna that may permit directional operation and an increased range. Preferably, the regional authority may equip a facility or component with enough reading devices to cover the entire portion of the facility based on the location of the stock and the effective range of a reading device 300.

MID tags may store at least 2 kilobytes of data and may be composed of a microchip, antenna and, in the case of active and semi-passive tags, a battery. The components of an RFID tag may be enclosed within plastic, silicon or glass. An RFID tag functions in the following manner: data stored on an RFLD tag's microchip waits to be read; the tag's antenna receives electromagnetic energy from an RFID reader's antenna; using power from its internal battery or power harvested from the reader's electromagnetic field, the tag sends radio waves back to the reader; the reader picks up the tag's radio waves and interprets the frequencies as meaningful data. Data stored on an RFID tag may be changed, updated and locked. According to one aspect of the present invention, the RFID tag is a chip that is embedded in a single item. The information stored on the embedded chip may be read by a reading device 300 and wirelessly transmitted to components of the supply chain as needed.

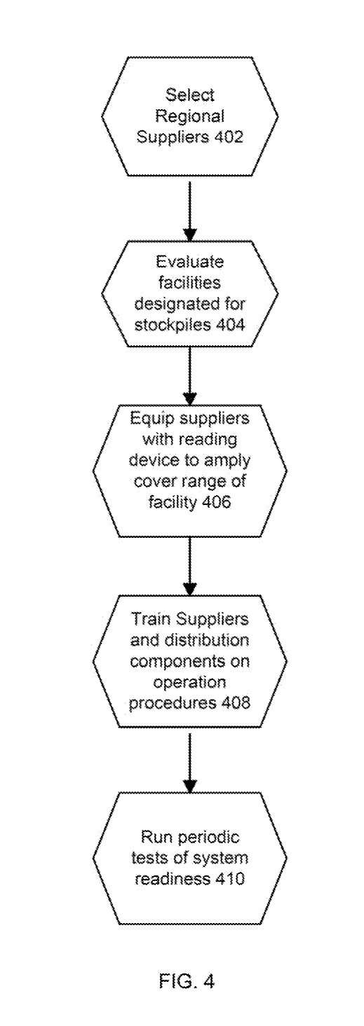

With reference now to FIG. 4, a flow chart diagram illustrating pre-disaster steps to establishing a virtual warehouse according to the present invention, will now be discussed. As shown in FIG. 4, a regional authority may select regional suppliers to participate in the emergency supply chain 402 and evaluate suppliers' facilities designated for stockpiling reserve supplies 404. Suppliers' may be equipped with an ample supply of reading devices 406. Regional authorities may ensure that registered suppliers and organizational components of each regional strategic alliance are in possession of and trained procedures to employ the reading device before a disaster situation occurs 408. After training operators on reading devices and RFID tags, periodic tests of system readiness 410 may be conducted to ensure overall system preparedness to implement standardized procedures. Each organizational component within the supply chain may be responsible for positioning at least one reading device depending on the strength of RFID reader range and the actual square footage of storage facilities for stockpiling supplies designated for disaster relief operations.

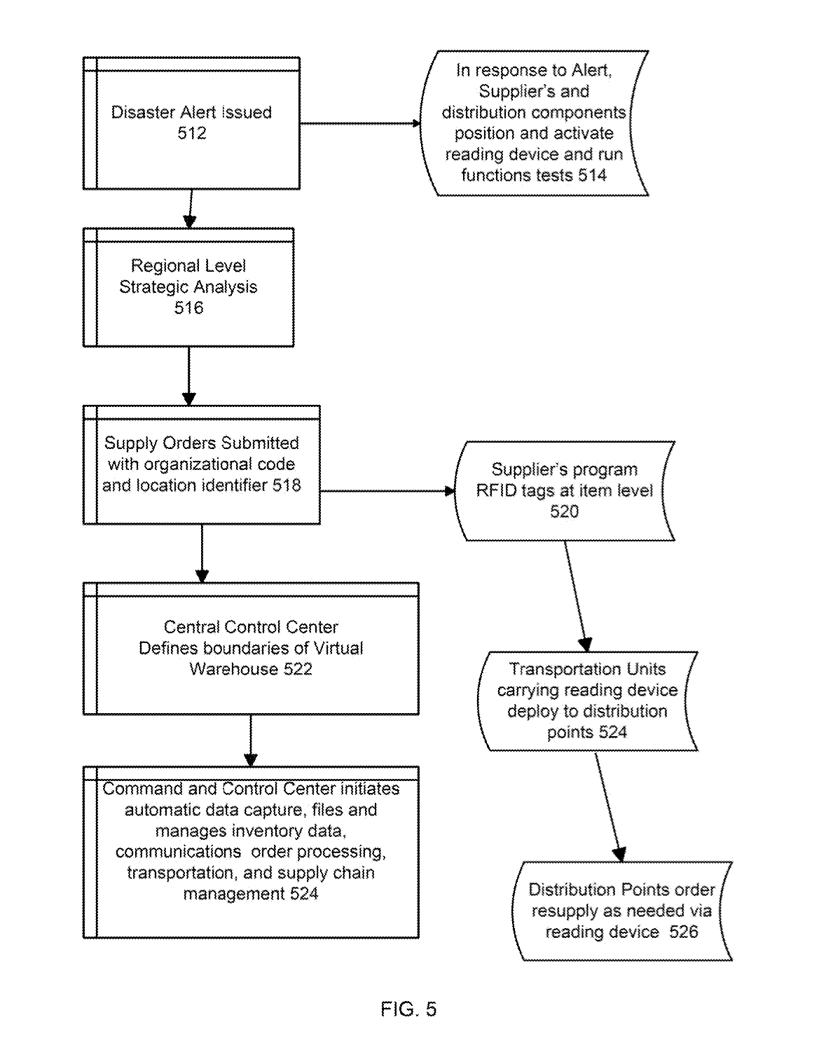

With reference to FIG. 5, a schematic diagram illustrating a preferred method for post-disaster procedures for conducting supply chain operations, will now be discussed. As shown in FIG. 5, a logistics center issues a disaster alert 512 mobilizing supplier's and distribution components to activate the reading devices 300 and run initial function tests 514 while awaiting orders. Preferably, response agencies will immediately conduct strategic analyses at the regional level. After receiving the initial estimates of the size and extent of damage, regional administrators may quickly assess and prioritize the areas of greatest immediate need 516. After communicating initial priorities, preferably orders for supply may be submitted along with operational codes and location designators 518. At which time suppliers' may update RFID tags to include the operational number and location designator at the item level 520. Then the transportation units may be loaded and deployed from supply facilities directly to distribution points 524. Each transportation unit will be equipped with at least one reading device 300. Supplies may be off-loaded at distribution points for immediate distribution to consumers. According to a preferred aspect of the present invention, distribution points may order resupply directly from their locations using reading devices assigned to the location 528.

As further shown in FIG. 5, the command and control center may automatically initiate an item level inventory within the system. This initial query is preferably configured to selectively capture data from any location within the virtual warehouse. Through this process, a reading device may read the RFID tag of each item within its range and store the item number identifier, expiration data and any other pertinent data stored pertaining to the specific item. The RFID reader may send information to the microcontroller unit where a GPS location coordinate may be applied to each item. During this process, the microcontroller unit may enumerate quantities transmitting information back to the central database 526.

According to a preferred embodiment of the present invention, the central database may be configured to collect and receive information provided by multiple reading devices from multiple sites across the geographic region of the virtual warehouse. With this information, the logistic center may define and update the boundaries of the virtual warehouse, manage inventory data, track processed orders and track and coordinate transportation within the supply chain 526. Preferably, a central database preferably queries the reading device 300 via its unique identifier code 526 to initiate an item level automatic data capture. Ideally, the virtual warehouse boundaries exist based on actual needs in a given region. Further, regional supply managers may consolidate and organize virtual warehouses minimizing oversupply and shortages between different regions.

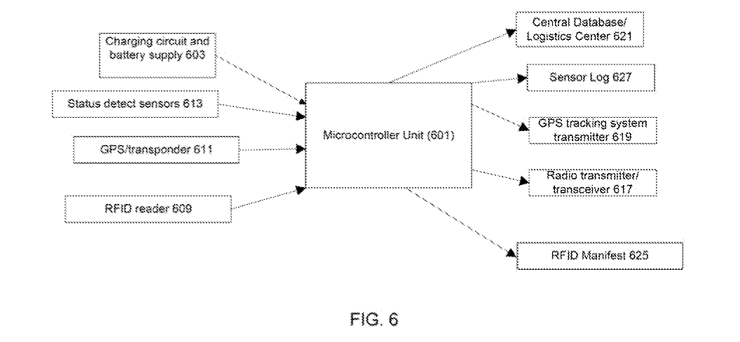

With reference now to FIG. 6, the details of a functional configuration of a microcontroller unit according to an embodiment of the present invention will now be discussed. A microcontroller unit 601 receives input from a charging circuit and battery cells 603, an RFID reader 609, the status detect sensors 613 and a GPS transponder 611. The microcontroller unit 601 then assesses all the information and sends out signals to a radio transmitter/transceiver 617, a GPS tracking system transmitter 619, an RFID manifest 625, a sensor log 627, and a remote monitoring station 621. Data from the reading device 300 is processed, stored, and acted upon by the microcontroller unit 601.

In operation, the microcontroller unit 601 is preferably programmed to routinely scan the conditions of the sensors to ensure operability. It may be further preferable, that the microcontroller unit 601 have access to all other subsystem managers of the sensor, communications, power, and alerting functions. To achieve this function, it is preferred that the controller 601 has access to and handles all of the system logging of sensor data on a sensor log 627 or similar medium. Further, it is preferred that the microcontroller unit 601 also process and store RFID data.

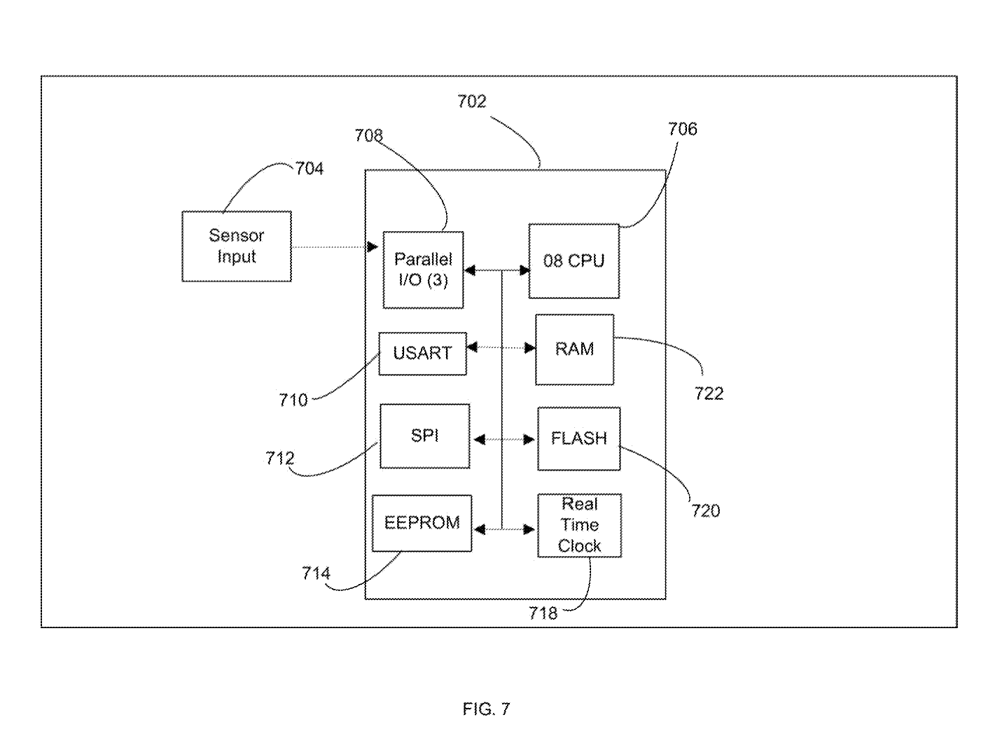

With reference now to FIG. 7, a sensor control unit in accordance with a preferred embodiment of the present invention, will now be discussed. As shown in FIG. 7, the microcontroller unit 702 incorporates a microprocessor 706, a real time clock 718, a general purpose Input/Output port to support external peripheral control 708, a Universal Synchronous/Asynchronous Receiver Transmitter (USA RT) 710, a Serial Port Interface (SPI) 712, and memory such as RAM 722, FLASH memory 720, and EEPROM 714 as shown. The microcontroller unit 702 receives, processes and stores information from sensor input 704.

Preferably, the microprocessor 706 used may be a low power, high performance, eight-bit intergrated circuit based on the Motorola HCS08 instruction set. The controller will preferably manage power and host the master date-time clock, communication scheduling and annotation of flash memory records.

### Communication System

In accordance with a preferred embodiment of the present invention, the reporting may be made via a wireless connection to a satellite mode to communicate with a satellite system such as Globalstar or Orbcomm. Preferably, such a satellite device will be a device such as the Axxon, AutoTracker, or the like, or a customized Orbcomm VHF satellite GPS tracking communications device which may be adapted with Zigbee interface antenna devices to incorporate them into the overall LAN architecture of the security system; these devices include a satellite transceiver, GPS receiver, a customized Zigbee wireless antenna with a serial (Ax Tracker) or duplex (OrbComm) interface.

In accordance with an alternative preferred embodiment of the present invention, the reporting may also be made using a wireless system independent from the satellite system. According to this embodiment, wireless signals may be transmitted to a wireless relay, base station or the like for routing and transmission to a chosen centralized location independent from or in combination with the transmissions made from the satellite system. In accordance with this alternative embodiment, signals may also be received by the communications manager and wireless interface from such external wireless networks as well.

According to a preferred embodiment of the present invention, it is preferred that the wireless communications used within the present invention will be based on the Zigbee (IEEE 802.15.4) standard. This standard transmits RF signals in the 2.4 GHz ISM band and operates with low power consumption due to its relatively slower data transmission rate (128 Kpps-250 Kbps). This approach enables additional capacity and flexibility of design through an up to 255 node pico-network. Communications are simplex or duplex in design, meaning that data can be assessed in either a push or pull process.

As referred to above, all communications of the present invention may be designed to be duplex or simplex in nature. Further, as needs require, the processes for transmitting data to and from the present invention may be designed to be push or pull in nature. Still, further, each feature of the present invention may be made to be remotely activated and accessed from distant monitoring stations. Accordingly, data may preferably be uploaded to and downloaded from present invention as needed. For example, as detailed above, each system and subsystem of the present invention may be designed to send, receive, report and request information via the wireless and/or satellite systems so as to continually maintain and update the container systems.

Additional communications with the communications manager are preferably enabled via industry standard wired interfaces, with communications protocols implemented in firmware for future upgrade. These interfaces preferably will include at least two RS-322 compatible serial ports. These alternate serial ports may assist the communications manager to interface with additional remote sensors as well as other local reader/controllers such as an RFID reader or other devices.

### Remote Monitoring

To support and monitor the dataflow generated by the present invention, it is preferred that users establish a centralized location to collect and analyze data. This central location or “data fusion center” would preferably consolidate all tracking signals, sensor alarms and reports generated by the monitoring systems and provide further context and links with current intelligence.

Preferably, such a data fusion center will receive such source information in a variety of formats such as Electronic Data Interchange, XML., E-mail, HTML and flat text files. After receiving such data, the data fusion center preferably would act to process information to identify anomalies. With this data collected and processed, analyst may calculate statistics and probability of detection models used for decision support. In short, such a data fusion center would preferably provide a consolidated source of information that could be used to assist agencies and shippers.

While the above descriptions regarding the present invention contains much specificity, these should not be construed as limitations on the scope, but rather as examples. Many other variations are possible. Accordingly, the scope should be determined not by the embodiments illustrated, but by the appended claims and their legal equivalents.

What is claimed is:

1. An apparatus for establishing a virtual warehouse and for managing a supply chain within an identified region, the apparatus comprising:
a receiving element for receiving RFID data and data regarding supply needs within an identified region; and
a processor configured to analyze RFID data and data regarding supply needs, wherein the processor is further configured to establish a geofenced area based on received data;
and further configured to generate requests for supplies to be transported into the geofenced area based on received data.

2. The apparatus of claim 1, wherein the receiving element is further configured to receive updated RFID data and updated data regarding supply needs; and further wherein, the processor is further configured to adjust the geofenced area based on the updated data.

3. The apparatus of claim 2, wherein the RFID data is obtained from the group consisting of an RFID tag, an embedded chip, a smart label or an intelligent barcode.

4. The apparatus of claim 3, wherein the RFID tag is passive, semi-passive or active.

5. A method for establishing a virtual warehouse within an identified region which is supplied by a supply chain, the method comprising:
receiving RFID data from items within the supply chain;
receiving need data regarding supply needs within an identified region;
comparing RFID data and need data;
establishing a geofenced area based on the RFID data and the need data;
generating requests for supplies to be transported into the geofenced area based on RFID data and need data;
updating RFID data and need data; and
redefining the geofenced area based on updated RFID data and need data.

6. The method of claim 6, wherein the method further comprises receiving geographic data and adjusting the geofenced area based on the geographic data.

7. The method of claim 6, wherein the method further comprises:
receiving and updating data regarding traffic patterns; and
redefining the geofenced area based on updated data regarding traffic patterns.
